(19) United States
(12) Patent Application Publication
(10) Pub. No.: US 2023/0012952 A1
(43) Pub. Date: Jan. 19, 2023

(54) Tool System

(71) Applicant: Robert Bosch GmbH, Stuttgart (DE)

(72) Inventors: Johannes Mueller, Zollikofen (CH); Milan Bozic, Luterbach (CH); Damian Brantschen, St. Niklaus (CH); Martin Wyden, Visp (CH); Damian Biner, Damian (CH)

(21) Appl. No.: 17/757,760

(22) PCT Filed: Dec. 14, 2020
(86) PCT No.: PCT/EP2020/085985

§ 371 Date: Jun. 20, 2022

(30) Foreign Application Priority Data
Dec. 23, 2019 (DE) 10 2019 220 528.3

(51) Int. Cl. B23D 61/00

(52) U.S. Cl. CPC B23D 61/006; B23D 61/025

(57) ABSTRACT

A tool system includes at least one machining tool, in particular at least one oscillating machining tool, and at least one additional machining tool, in particular at least one additional oscillating machining tool. The at least one machining tool and the at least one additional machining tool are of the same type, and the at least one machining tool and the at least one additional machining tool differ from each other in at least one cutting blade characteristic, in particular cutting edge characteristic.

### PRIOR ART

A tool system comprising at least one machining tool, in particular at least one oscillating machining tool, and at least one additional machining tool, in particular at least one additional oscillating machining tool, has already been proposed.

### DISCLOSURE OF THE INVENTION

The invention is based on a tool system comprising at least one machining tool, in particular at least one oscillating machining tool, and at least one additional machining tool, in particular at least one additional oscillating machining tool, wherein the at least one machining tool and the at least one additional machining tool are of the same type, wherein the at least one machining tool and the at least one additional machining tool differ from each other in at least one cutting blade characteristic, in particular cutting edge characteristic.

The tool system may preferably comprise a plurality of machining tools, in particular at least one additional machining tool in addition to the at least one machining tool and the at least one additional machining tool. As an alternative to an embodiment as oscillating machining tools, it is conceivable that the machining tools are configured as rotary machining tools, as pendulum machining tools or as other machining tools appearing expedient to a person skilled in the art. Preferably, the machining tools are configured as cutting tools, as grinding tools, as sawing tools, or the like. The machining tools are preferably provided for use with a machine tool, in particular an oscillating machine tool. In particular, the machining tools are provided for use with the same machine tool. In particular, the oscillating machine tool is provided to drive a coupled machining tool for an, in particular, oscillating, movement. “Provided” is intended to be understood to mean, in particular, specifically designed and/or specifically equipped. An object being provided for a specific function is intended to be understood to mean, in particular, that the object fulfills and/or performs this specific function in at least one use state and/or operating state.

Preferably, the machining tools have at least one base body and at least one coupling interface which is defined and/or formed by the base body for coupling to a tool receiver of the machine tool. The machining tools preferably have at least one cutting blade which is provided for machining workpieces. The cutting blade is connected, in particular, to the base body, in particular welded, riveted, screwed or connected to the base body in a different manner appearing expedient to a person skilled in the art, or configured integrally with the base body. “Integrally” is intended to be understood to mean, in particular, formed in one piece. Preferably, this one piece is produced from a single blank, a mass and/or a casting, particular preferably in an injection-molding method, in particular a one-component and/or multi-component injection-molding method. The cutting blade may be configured, in particular, from a different material from a material of the base body. Preferably, the cutting blade has a cutting edge, in particular on a side remote from the base body. The cutting edge may have, in particular, cutting teeth. In particular, the cutting edge is provided to cut through, in particular to cut and/or to saw, a workpiece at least in some sections. Preferably, the at least one machining tool is provided, in particular optimized in terms of its properties, for machining other workpieces, in particular workpieces made of a different material from the at least one additional machining tool. In particular, it is conceivable that the at least one machining tool is provided, in particular is optimized, for machining workpieces made of a metal and the at least one additional machining tool is provided, in particular is optimized, for machining workpieces made of a hard wood. In particular, the at least one additional machining tool may be provided, in particular optimized, for machining workpieces made of chipboard panels.

Preferably, the at least one machining tool and the at least one additional machining tool are of the same type, having in particular at least the same maximum main longitudinal extensions, at least the same coupling interfaces, at least the same connections between the base bodies and the cutting blades, at least the same shapes, at least the same cutting blade tapers, at least the same base body materials, at least the same material thicknesses, in particular base body material thicknesses and/or cutting blade material thicknesses, or the like. A “main longitudinal extension” of an object is intended to be understood to mean, in particular, an extension of the object in a main longitudinal direction of extension of the object. A “main longitudinal direction of extension” of an object is intended to be understood to mean, in particular, a direction which runs parallel to a longest edge of a smallest geometric cuboid which only just fully encloses the object. A “material thickness” of an object is intended to be understood to mean, in particular, a maximum extension of a material of the object at least substantially perpendicular to a plane extending at least substantially parallel to the main longitudinal extension of the object. The expression “substantially perpendicular” is intended to be understood to mean, in particular, an orientation of a direction relative to a reference direction, wherein the direction and the reference direction, in particular when viewed in a projection plane, enclose an angle of 90°, and the angle has a maximum deviation of, in particular, less than 8°, advantageously less than 5° and particularly advantageously less than 2°. “Substantially parallel” is intended to be understood to mean, in particular, an orientation of a direction relative to a reference direction, in particular in one plane, wherein the direction relative to the reference direction has a deviation, in particular, of less than 8°, advantageously less than 5°, and particularly advantageously less than 2°. Preferably, the at least one machining tool and the at least one additional machining tool may be packaged, presented and/or sold in the same packaging. In particular, the at least one machining tool and the at least one additional machining tool may be produced in a production method which is the same at least in some sections.

The at least one cutting blade characteristic, in which the at least one machining tool and the at least one additional machining tool differ from each other, is preferably configured as a cutting edge characteristic. Alternatively or additionally, it is conceivable that the at least one cutting blade characteristic, in which the at least one machining tool and the at least one additional machining tool differ from each other, is configured as a characteristic of parts of the cutting blades which are different from the cutting edges. In particular, the at least one machining tool and the at least one additional machining tool may differ from each other in a plurality of different cutting blade characteristics, in particular cutting edge characteristics. The at least one cutting blade characteristic, in particular cutting edge characteristic, may be configured in particular as a hardness parameter, as a breaking strength parameter, as a geometry parameter or as a different cutting blade characteristic appearing expedient to a person skilled in the art.

Advantageously, by means of the embodiment according to the invention of the tool system, it is possible to provide machining tools which are optimized for different machining tasks. Advantageously, a user of the tool system may be given a familiar, in particular standardized, user experience with different machining tools. Advantageously, it is possible to provide a tool system which is standardized, in particular which may be produced and distributed in an efficient and resource-saving manner Moreover, it is proposed that the at least one cutting blade characteristic is configured as a hardness parameter and/or as a breaking strength parameter. The hardness parameter describes, in particular, a hardness of the cutting blades, in particular of the cutting edges. The breaking strength parameter describes, in particular, a breaking strength of the cutting blades, in particular the cutting edges. In particular cutting blades, in particular cutting edges, having a different hardnesses and/or different breaking strength are suitable to different degrees for machining different materials. In particular, a cutting blade, in particular a cutting edge, with a specific hardness and a specific breaking strength may be well suited for machining metals. In particular, an additional cutting blade, in particular an additional cutting edge, with a greater hardness than the cutting blade provided for the metal machining, may be well suited for machining chipboard panels, in particular for reducing cutting blade erosion.

In particular, the cutting blade provided for metal machining may have a greater breaking strength than the additional cutting blade provided for chipboard panel machining, in particular for compensating for impacts on the cutting blade during metal machining. Preferably, the cutting blade, in particular the cutting edge, of the at least one machining tool and the cutting blade, in particular the cutting edge, of the at least one machining tool may be configured from materials having different hardnesses and/or breaking strengths, may have different coatings, may be shaped differently, in particular have differently shaped cutting teeth, may have different types of connection between the cutting edges and base parts of the cutting blades or the like, for implementing different hardnesses parameters and/or different breaking strength parameters. Advantageously, it is possible to provide machining tools which are optimized by different hardnesses and/or breaking strengths for machining different materials. It is further proposed that the at least one cutting blade characteristic is configured as a geometry parameter. The geometry parameter describes, in particular, a shaping of the cutting blades, in particular the cutting edges. In particular, the cutting edges may be differently shaped. For example, it is conceivable that the cutting edge of the cutting blade of the at least one machining tool is configured in a linear manner and that the cutting edge of the cutting blade of the at least one additional machining tool is configured in an arcuate manner, in particular has a radius of curvature. In particular, the individual cutting teeth of the cutting edges may have different shapes, in particular different round shapes of the tooth tips, different sizes, or the like. In particular, a plurality of cutting teeth may be arranged in the form of a complete row of teeth or as individual teeth separately from each other on the base parts of the cutting blades. Advantageously, it is possible to provide machining tools which are optimized by different geometries for machining different materials. It is further proposed that the at least one machining tool has a material composition of at least one, in particular the aforementioned, cutting edge of the at least one machining tool, which differs from a material composition of at least one, in particular the aforementioned, cutting edge of the at least one additional machining tool. In particular, the cutting edges of the machining tools may have different material compositions for implementing different hardnesses and/or breaking strengths of the cutting edges. Preferably, the cutting edges are configured, in particular, from different hard metals. In particular, the cutting edges configured from hard metals may differ at least in a proportion of cobalt in the material composition.

In particular, the lower the proportion of cobalt in the material composition, the harder the cutting edge. In particular, the higher the proportion of cobalt in the material composition, the more break-resistant the cutting edge. Alternatively or additionally to a configuration from a hard metal, it is conceivable that the cutting edge of at least one of the machining tools is configured from a bimetal, from a high-speed steel, from a high-strength unalloyed steel or from a different material appearing expedient to a person skilled in the art. In particular, the cutting edges in the connecting regions with the base parts of the cutting blades may differ in a material composition, in particular as a function of different types of connection, for example soldered connections, welded connections, adhesively bonded connections, additive connections or the like. Advantageously, machining tools which are of the same type may be provided with material compositions which are optimized for different machining tasks. Additionally, it is proposed that the at least one machining tool has at least one coating of at least one, in particular the aforementioned, cutting edge of the at least one machining tool, which differs from at least one coating of at least one, in particular the aforementioned, cutting edge of the at least one additional machining tool. In particular, the cutting edges of the machining tools may have different coatings for implementing different hardnesses, breaking strengths, surface qualities and/or contour accuracies of the cutting edges. The coatings of the cutting edges may differ, in particular, in a material composition of the coatings, in a thickness of the coatings, in a number of, in particular different, layers of the coatings and/or in other coating parameters appearing expedient to a person skilled in the art. Alternatively, it is conceivable that at least one of the cutting edges is configured to be free of a coating and/or a surface treatment, in particular for increasing the surface quality.

Preferably, the coatings may consist of different materials, for example of a TiAlN (Titanium aluminum nitride), of a TiAlCN (Titanium aluminum carbon nitride), of a TiN (Titanium Nitride) or the like. Preferably, the coatings have a maximum thickness of at most 5 μm. In particular, the cutting edges may differ from each other in an application position of the coatings. In particular, a complete cutting edge, merely the cutting teeth of the cutting edge, merely the tooth tips of the cutting teeth or merely the tooth bodies of the cutting teeth may have a coating. Preferably, the coatings of the cutting edges may be dependent on the hardnesses and/or the breaking strengths of the cutting edges. For example, it is conceivable that a particularly break-resistant but less hard cutting edge has a hard coating for increasing the hardness. Advantageously, it is possible to provide machining tools which are of the same type with coatings which are optimized for different machining tasks.

Moreover, it is proposed that the at least one machining tool has at least one identification label which differs, as a function of the at least one cutting blade characteristic, from at least one identification label of the at least one additional machining tool. Preferably, the identification labels are applied onto the base bodies, in particular in regions of the coupling interfaces and/or onto the cutting blades of the machining tools. Preferably, the identification labels are configured as optical identification labels, in particular as differently colored markings, as different patterns, as different numerals, as different letters, as different symbols or the like. Alternatively or additionally, it is conceivable that the identification labels are configured as haptic identification labels, in particular as different profiles, as different raised portions, as different letters or numerals in a braille text or the like. In particular, the identification labels may be applied by a laser inscription, by a printing, by a stamping or the like onto the base bodies and/or the cutting blades. Preferably, the identification labels are dependent on the hardness parameters, on the breaking strength parameters, on the geometry parameters, on the material compositions and/or on the coatings of the machining tools. In particular, the identification labels are provided to display to a user the materials for which the machining tools are provided, in particular are optimized, for machining. Advantageously, it is possible to provide a user-friendly tool system.

It is further proposed that the tool system has at least one, in particular the aforementioned, machine tool, in particular an oscillating machine tool, which is couplable to the at least one machining tool and to the at least one additional machining tool. In particular, the tool receiver of the machine tool is couplable to the coupling interfaces of the machining tools. Preferably, the machine tool is configured as a multifunction machine tool, in particular as an oscillating multifunction machine tool. In particular, the machine tool is configured as a hand-held machine tool. Preferably, the machine tool is configured as electric machine tool, in particular as a battery-driven and/or cable-connected machine tool. Advantageously, it is possible to provide machining tools which may be used by the same machine tool for machining different materials.

The invention is also based on a method for producing a tool system, in particular a tool system according to the invention, in particular of at least one, in particular the aforementioned, machining tool and at least one, in particular the aforementioned, additional machining tool of the tool system.

It is proposed that the at least one machining tool and the at least one additional machining tool carry out at least one common method step during production. In particular, the machining tools may carry out a plurality of common method steps during production. The at least one common method step may be configured, in particular, as a reshaping step for forming the base bodies, in particular the coupling interfaces, as a stamping step for forming the cutting blades, as a connecting step for connecting the cutting blades to the base bodies and as an additional method step appearing expedient to a person skilled in the art. In particular, in the reshaping step the coupling interfaces may be formed by reshaping a strip material, in particular a heat-treatable steel. In particular, the strip material has a material thickness of at least 0.8 mm and at most 2 mm. Advantageously, it is possible to provide an efficient production method.

Additionally, it is proposed that in at least one method step at least one, in particular the aforementioned, cutting blade of the at least one machining tool and at least one, in particular the aforementioned, cutting blade of the at least one additional machining tool may be produced, in particular stamped, from a common blank. In particular, the at least one method step in which the cutting blade, in particular the base part of the cutting blade, of the at least one machining tool and the cutting blade, in particular the base part of the cutting blade, of the at least one additional machining tool may be produced, in particular stamped, from a common blank, is configured as a common method step. Preferably, the common blank is configured as a strip material, in particular made of a high-speed steel or made of a bimetal. In particular, the common blank has a material thickness of at least 0.5 mm and at most 1.5 mm. Preferably, the cutting blades, in particular the base parts of the cutting blades, are stamped from the common blank. Advantageously, a standardized, in particular resource-saving, production process may be permitted.

Moreover, it is proposed that at least one, in particular the aforementioned, cutting edge of the at least one machining tool and at least one, in particular the aforementioned, cutting edge of the at least one additional machining tool may be differently post-treated in at least one method step. In particular, a different post-treatment of the cutting edges may be configured, in particular, as a heat treatment, as an application of a coating, as a sand blasting, as a milling, as a grinding, as an erosion, as an anti-rust treatment, as a brushing and/or as an additional post-treatment appearing expedient to a person skilled in the art. Preferably, the cutting edges of the machining tools are post-treated for achieving different hardnesses, different breaking strengths and/or different geometries of the cutting edges. Advantageously, it is possible to produce machining tools which are optimized for different treatment tasks.

The invention is further based on a machining tool, in particular on the aforementioned additional machining tool or on the aforementioned additional machining tool, in particular an oscillating machining tool of a tool system according to the invention and/or produced in a method according to the invention. Advantageously, it is possible to provide machining tools which are optimized for a specific treatment task.

The tool system according to the invention, the method according to the invention and/or the machining tool according to the invention in this case are not intended to be limited to the above-described use and embodiment. In particular, the tool system according to the invention, the method according to the invention and/or the machining tool according to the invention for fulfilling a mode of operation described herein may have a number of elements, components and units which differs from a number thereof cited herein. Additionally, in the value ranges specified in this disclosure, values within the cited limits are also intended to be regarded as disclosed and able to be used in any manner.

### DRAWINGS

Further advantages emerge from the following description of the drawings. An exemplary embodiment of the invention is shown in the drawings. The drawings, the description and the claims contain numerous features in combination. The person skilled in the art will also expediently consider the features individually and combine them together to form further meaningful combinations.

In the drawings:

FIG. 1 shows a tool system according to the invention in a schematic view,

FIG. 2 shows a part of the tool system according to the invention of FIG. 1 in a schematic view, and

FIG. 3 shows a flow diagram of a method according to the invention for producing the tool system according to the invention of FIG. 1 in a schematic view.

### DESCRIPTION OF THE EXEMPLARY EMBODIMENT

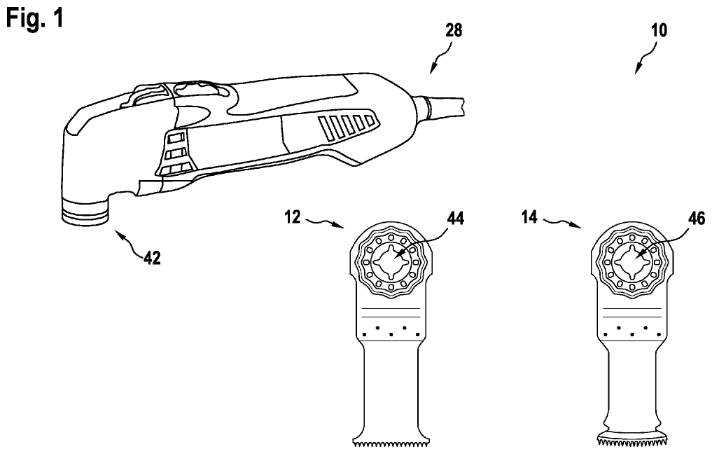

FIG. 1 shows a tool system 10 in a schematic view. Preferably, the tool system 10 comprises at least one machining tool 12, in particular at least one oscillating machining tool, and at least one additional machining tool 14, in particular at least one additional oscillating machining tool, wherein the at least one machining tool 12 and the at least one additional machining tool 14 are of the same type, wherein the at least one machining tool 12 and the at least one additional machining tool 14 differ from each other in at least one cutting blade characteristic, in particular cutting edge characteristic. The tool system 10 may preferably comprise a plurality of machining tools 12, 14, in particular at least one additional machining tool, in addition to the at least one machining tool 12 and the at least one additional machining tool 14 (not shown here). As an alternative to a configuration as oscillating machining tools, it is conceivable that the machining tools 12, 14 are configured as rotary machining tools, as pendulum machining tools or as other machining tools 12, 14 appearing expedient to a person skilled in the art. Preferably, the machining tools 12, 14 are configured as cutting tools, as grinding tools, as sawing tools, or the like. The machining tools 12, 14 are preferably provided for use with a machine tool 28, in particular with an oscillating machine tool, in particular of the tool system 10. In particular, the machining tools 12, 14 are provided for use with the same machine tool 28. In particular, the machine tool 28 which is configured as an oscillating machine tool is provided to drive a coupled machining tool 12, 14, in particular for an oscillating movement.

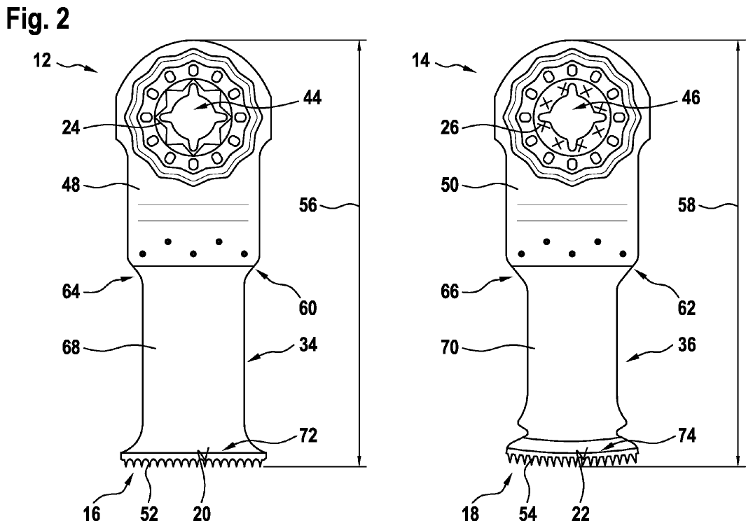

Preferably, the tool system 10 has at least one, in particular the aforementioned, machine tool 28, in particular an oscillating machine tool, which is couplable to the at least one machining tool 12 and to the at least one additional machining tool 14. In particular, a tool receiver 42 of the machine tool 28 is couplable to coupling interfaces 44, 46 of the machining tools 12, 14. Preferably, the machine tool 28 is configured as a multifunction machine tool, in particular as an oscillating multifunction machine tool. In particular, the machine tool 28 is configured as a hand-held machine tool. Preferably, the machine tool 28 is configured as an electric machine tool, in particular as a battery-driven and/or cable-connected machine tool 28, as by way of example in the present exemplary embodiment. FIG. 2 shows a part of the tool system 10, in particular the machining tool 12 and the additional machining tool 14 of FIG. 1 in a schematic view. Preferably, the machining tools 12, 14 have at least one base body 48, 50 and the at least one coupling interface 44, 46 which is defined and/or formed by the base body 48, 50 for coupling to the tool receiver 42 of the machine tool 28. The machining tools 12, 14 preferably have at least one cutting blade 34, 36 which is provided for machining workpieces. The cutting blade 34, 36 is connected, in particular, to the base body 48, 50, as for example in the present exemplary embodiment, in particular welded, riveted, screwed or connected to the base body 48, 50 in a different manner appearing expedient to a person skilled in the art, or configured integrally with the base body 48, 50. The cutting blade 34, 36 may be configured, in particular, from a different material from a material of the base body 48, 50. Preferably, the cutting blade 34, 36 has a cutting edge 16, 18, in particular on a side remote from the base body 48, 50. The cutting edge 16, may have, in particular, cutting teeth 52, 54. In particular, the cutting edge 16, 18 is provided to cut through, in particular to cut and/or to saw, a workpiece at least in some sections.

Preferably, the at least one machining tool 12 is provided, in particular optimized in terms of its properties, for machining other workpieces, in particular workpieces made of a different material from the at least one additional machining tool 14. In particular, it is conceivable that the at least one machining tool 12 is provided, in particular is optimized, for machining workpieces made of a metal and the at least one additional machining tool 14 is provided, in particular is optimized, for machining workpieces made of a hardwood or chipboard panels.

Preferably, the at least one machining tool 12 and the at least one additional machining tool 14 are of the same type, having in particular at least the same maximum main longitudinal extensions 56, 58, at least the same coupling interfaces 44, 46, at least the same connections 60, 62 between the base bodies 48, 50 and the cutting blades 34, 36, at least the same shapes, at least the same cutting blade tapers 64, 66, at least the same base body materials, at least the same material thicknesses, in particular base body material thicknesses and/or cutting blade material thicknesses, or the like. Preferably, the at least one machining tool 12 and the at least one additional machining tool 14 may be packaged, presented and/or sold in the same packaging. In particular, the at least one machining tool 12 and the at least one additional machining tool 14 may be produced in a production method which is the same at least in some sections.

The at least one cutting blade characteristic, in which the at least one machining tool 12 and the at least one additional machining tool 14 differ from each other, is preferably configured as a cutting edge characteristic. Alternatively or additionally, it is conceivable that the at least one cutting blade characteristic, in which the at least one machining tool 12 and the at least one additional machining tool 14 differ from each other, is provided as a characteristic of parts of the cutting blades 34, 36 which are different from the cutting edges 16, 18. In particular, the at least one machining tool 12 and the at least one additional machining tool 14 may differ from each other in a plurality of different cutting blade characteristics, in particular cutting edge characteristics. The at least one cutting blade characteristic, in particular cutting edge characteristic, may be configured in particular as a hardness parameter, as a breaking strength parameter, as a geometry parameter or as a different cutting blade characteristic appearing expedient to a person skilled in the art.

Preferably, the at least one cutting blade characteristic is configured as a hardness parameter and/or as a breaking strength parameter. The hardness parameter describes, in particular, a hardness of the cutting blades 34, 36, in particular of the cutting edges 16, 18. The breaking strength parameter describes, in particular, a breaking strength of the cutting blades 34, 36, in particular the cutting edges 16, 18. In particular, cutting blades 34, 36, in particular cutting edges 16, 18, having different hardnesses and/or breaking strengths are suitable to different degrees for machining different materials. In particular, a cutting blade 34, in particular a cutting edge 16, with a specific hardness and a specific breaking strength may be well suited for machining metals. In particular, an additional cutting blade 36, in particular an additional cutting edge 18, with a greater hardness than the cutting blade 34 provided for metal machining, in particular for reducing a cutting blade erosion, may be well suited for machining chipboard panels. In particular, the cutting blade 34 provided for metal machining may have a higher breaking strength than the cutting blade 36 provided for machining chipboard panels, in particular for compensating for impacts on the cutting blade 34 during metal machining. Preferably, the cutting blade 34, in particular the cutting edge 16, of the at least one machining tool 12, and the cutting blade 36, in particular the cutting edge 18, of the at least one machining tool 14 may be configured from materials having different hardnesses and/or breaking strengths, may have different coatings 20, 22, may be shaped differently, in particular may have differently shaped cutting teeth 52, 54, may have different types of connection between the cutting edges 16, 18 and the base parts 68, 70 of the cutting blades 34, 36, or the like, for implementing different hardnesses parameters and/or different breaking strength parameters. Preferably, the at least one cutting blade characteristic is configured as geometry parameter. The geometry parameter describes, in particular, a shaping of the cutting blades 34, 36, in particular the cutting edges 16, 18. In particular, the cutting edges 16, 18 may be differently shaped. For example, it is conceivable that the cutting edge 16 of the cutting blade 34 of the at least one machining tool 12 is configured in a linear manner and that the cutting edge 18 of the cutting blade 36 of the at least one additional machining tool 14 is configured in an arcuate manner, in particular has a radius of curvature, as by way of example in the present exemplary embodiment. In particular, the individual cutting teeth 52, 54 of the cutting edges 16, 18 may have different shapes, in particular different round shapes of the tooth tips, different sizes, or the like. In particular, a plurality of cutting teeth 52, 54 may be arranged in the from of a complete row of teeth or as individual teeth separately from each other on the base parts 68, 70 of the cutting blades 34, 36.

Preferably, the at least one machining tool 12 has a material composition of at least one, in particular the aforementioned, cutting edge 16 of the at least one machining tool 12, which differs from a material composition of at least one, in particular the aforementioned, cutting edge 18 of the at least one additional machining tool 14. In particular, the cutting edges 16, 18 of the machining tools 12, 14 may have different material compositions for implementing different hardnesses and/or breaking strengths of the cutting edges 16, 18. Preferably, the cutting edges 16, 18 are configured, in particular, from different hard metals. In particular, the cutting edges 16, 18 configured from hard metals may differ at least in a proportion of cobalt in the material composition. In particular, the lower the proportion of cobalt in the material composition, the harder the cutting edge 16, 18. In particular, the higher the proportion of cobalt in the material composition, the more break-resistant the cutting edge 16, 18. Alternatively or additionally to a configuration from a hard metal, it is conceivable that the cutting edge 16, 18 of at least one of the machining tools 12, 14 is configured from a bimetal, from a high-speed steel, from a high-strength unalloyed steel or from a different material appearing expedient to a person skilled in the art. In particular, the cutting edges 16, 18 in connecting regions 72, 74 with the base parts 68, 70 of the cutting blades 34, 36 may differ in a material composition, in particular as a function of different types of connection, for example soldered connections, welded connections, adhesively bonded connections, additive connections, or the like.

Preferably, the at least one machining tool 12 has at least one coating 20 of at least one, in particular the aforementioned, cutting edge 16 of the at least one machining tool 12 which differs from at least one coating 22 of at least one, in particular the aforementioned, cutting edge 18 of the at least one additional machining tool 14. In particular, the cutting edges 16, 18 of the machining tools 12, 14 may have different coatings 20, 22 for implementing different hardnesses, breaking strengths, surface qualities and/or contour accuracies of the cutting edges 16, 18. The coatings 20, 22 of the cutting edges 16, 18 may differ, in particular, in a material composition of the coatings 20, 22, in a thickness of the coatings 20, 22, in a number of, in particular different, layers of the coatings 20, 22 and/or in other coating parameters appearing expedient to a person skilled in the art. Alternatively, it is conceivable that at least one of the cutting edges 16, 18 is configured to be free of a coating 20, 22 and/or a surface treatment, in particular for increasing the surface quality. Preferably, the coatings 20, 22 may consist of different materials, for example of a TiAlN, of a TiAlCN, of a TiN, or the like. Preferably, the coatings 20, 22 may have a maximum thickness of at most 5 μm. In particular, the cutting edges 16, 18 may differ from each other in an application position of the coatings 20, 22. In particular, a complete cutting edge 16, 18, merely the cutting teeth 52, 54 of the cutting edge 16, 18, merely the tooth tips of the cutting teeth 52, 54 or merely the tooth bodies of the cutting teeth 52, 54 may have a coating 20, 22. Preferably, the coatings 20, 22 of the cutting edges 16, 18 may be dependent on the hardnesses and/or the breaking strengths of the cutting edges 16, 18. For example, it is conceivable that a particularly break-resistant but less hard cutting edge 16, 18 has a hard coating 20, 22 for increasing the hardness.

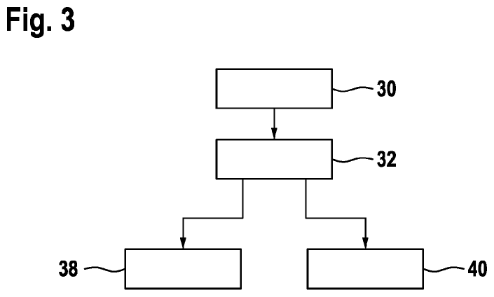

Preferably, the at least one machining tool 12 has at least one identification label 24 which differs, as a function of the at least one cutting blade characteristic, from at least one identification label 26 of the at least one additional machining tool 14. Preferably, the identification labels 24, 26 are applied onto the base bodies 48, 50, in particular in regions of the coupling interfaces 44, 46, as by way of example in the present exemplary embodiment, and/or onto the cutting blades 34, 36 of the machining tools 12, 14. Preferably, the identification labels 24, 26 are configured as optical identification labels, in particular as differently colored markings, as different patterns, as different numerals, as different letters, as different symbols, or the like. Alternatively or additionally, it is conceivable that the identification labels 24, 26 are configured as haptic identification labels, in particular as different profiles, as different raised portions, as different letters or numerals in a braille text, or the like. In particular, the identification labels 24, 26 may be applied by a laser inscription, by a printing, by a stamping or the like onto the base bodies 48, 50 and/or the cutting blades 34, 36. Preferably, the identification labels 24, 26 are dependent on the hardness parameters, on the breaking strength parameters, on the geometry parameters, on the material compositions and/or on the coatings 20, 22 of the machining tools 12, 14. In particular, the identification labels 24, 26 are provided to display to a user the materials for which the machining tools 12, 14 are provided, in particular are optimized, for machining. FIG. 3 shows a flow diagram of a method for producing a tool system, in particular the tool system 10 of FIG. 1. in particular of at least one, in particular the aforementioned, machining tool 12 and of at least one, in particular the aforementioned, additional machining tool 14 in a schematic view. Preferably, the at least one machining tool 12 and the at least one additional machining tool 14 carry out at least one common method step 30, 32 during production. In particular, the machining tools 12, 14 may carry out a plurality of common method steps 30, 32, in the present exemplary embodiment for example two common method steps 30, 32, during production. The at least one common method step 30, 32 may be configured, in particular, as a reshaping step for forming the base bodies 48, 50, in particular the coupling interfaces 44, 46, as a stamping step for forming the cutting blades 34, 36, as a connecting step for connecting the cutting blades 34, 36 to the base bodies 48, 50 or as an additional method step appearing expedient to a person skilled in the art. In the present exemplary embodiment, by way of example the reshaping step forms a common method step 30 and the stamping step forms an additional common method step 32. In particular, in the reshaping step the coupling interfaces 44, 46 may be formed by reshaping a strip material, in particular a heat-treatable steel. In particular, the strip material has a material thickness of at least 0.8 mm and at most 2 mm.

Preferably, in at least one, in particular in the additional common method step 32, at least one, in particular the aforementioned, cutting blade 34 of the at least one machining tool 12 and at least one, in particular the aforementioned, cutting blade 36 of the at least one additional machining tool 14 are produced, in particular stamped, from a common blank. Preferably, the common blank is configured as a strip material, in particular made of a high-speed steel or made of a bimetal (not shown here), in particular the common blank has a material thickness of at least 0.5 mm and at most 1.5 mm. Preferably, the cutting blades 34, 36, in particular the base parts 68, 70 of the cutting blades 34, 36, are stamped from the common blank.

Preferably, in at least one additional method step 38, 40 at least one, in particular the aforementioned, cutting edge 16 of the at least one machining tool 12 and at least one, in particular the aforementioned, cutting edge 18 of the at least one additional machining tool 14 are differently post-treated. In particular, the cutting edge 16 of the at least one machining tool 12 may be post-treated in an additional method step 38, and the cutting edge 18 of the at least one additional machining tool 14 may be post-treated in an additional method step 40, in particular carried out parallel to the additional method step 38. In particular, a different post-treatment of the cutting edges 16, 18 may be configured, in particular, as a heat treatment, as an application of a coating 20, 22, as a sand blasting, as a milling, as a grinding, as an erosion, as an anti-rust treatment, as a brushing and/or as an additional post-treatment appearing expedient to a person skilled in the art. Preferably, the cutting edges 16, 18 of the machining tools 12, 14 are post-treated for achieving different hardnesses, different breaking strengths and/or different geometries of the cutting edges 16, 18.

Regarding additional method steps of the method for producing the tool system 10, reference may be made to the above description of the tool system 10, since this description may be read in a similar manner to the method, and thus all features regarding the tool system 10 are also considered as disclosed relative to the method for producing the tool system 10.

1. A tool system comprising:
at least one machining tool; and
at least one additional machining tool,
wherein the at least one machining tool and the at least one additional machining tool are of the same type, and
wherein the at least one machining tool and the at least one additional machining tool differ from each other in at least one cutting blade characteristic.

2. The tool system as claimed in claim 1, wherein the at least one cutting blade characteristic is a hardness parameter and/or as a breaking strength parameter.

3. The tool system as claimed in claim 1, wherein the at least one cutting blade characteristic is a geometry parameter.

4. The tool system as claimed in claim 1, wherein the at least one machining tool has a first material composition of at least one first cutting edge of the at least one machining tool which differs from a second material composition of at least one second cutting edge of the at least one additional machining tool.

5. The tool system as claimed in claim 1, wherein the at least one machining tool has at least one first coating of at least one first cutting edge of the at least one machining tool which differs from at least one second coating of at least one second cutting edge of the at least one additional machining tool.

6. The tool system as claimed in claim 1, wherein the at least one machining tool has at least one first identification label which differs, as a function of the at least one cutting blade characteristic, from at least one second identification label of the at least one additional machining tool.

7. The tool system as claimed in claim 1, further comprising:
at least one machine tool configured to couple to the at least one machining tool and to the at least one additional machining tool.

8. A method for producing a tool system having at least one machining tool and at least one additional machining tool that is of the same type as the at least one machining tool and differs from the at least one machining tool in at least one cutting blade characteristic, the method comprising:
producing the at least one machining tool and the at least one additional machining tool with at least one common production step.

9. The method as claimed in claim 8, wherein in the common production step, at least one first cutting blade of the at least one machining tool and at least one second cutting blade of the at least one additional machining tool are stamped from a common blank.

10. The method as claimed in claim 8, further comprising:
post-treating at least one first cutting edge of the at least one machining tool and at least one second cutting edge of the at least one additional machining tool differently.

11. The machining tool of the tool system as claimed in claim 1.

12. The tool system as claimed in claim 1, wherein the at least one machining tool is at least one oscillating machining tool, the at least one additional machining tool is at least one additional oscillating machining tool, and the at least one machining tool and the at least one additional machining tool differ from one another in at least one cutting edge characteristic.

13. The tool system as claimed in claim 12, further comprising:
an oscillating machine tool configured to couple to the at least one oscillating machining tool and to the at least one additional oscillating machining tool.
